(19) United States
(12) Patent Application Publication
(10) Pub. No.: US 2014/0279476 A1
(43) Pub. Date: Sep. 18, 2014

(54) Multiple Account Dynamic Card Apparatuses, Methods and Systems

(71) Applicant: VISA INTERNATIONAL SERVICE ASSOCIATION, San Francisco, CA (US)

(72) Inventor: Julian Hua, San Francisco, CA (US)

(73) Assignee: VISA INTERNATIONAL SERVICE ASSOCIATION, San Francisco, CA (US)

(21) Appl. No.: 14/216,307

(22) Filed: Mar. 17, 2014

Related U.S. Application Data
(60) Provisional application No. 61/800,909, filed on Mar. 15, 2013.

(51) Int. Cl. G06Q 20/22; G06Q 20/40; G06Q 20/34; G06K 19/077

(52) U.S. Cl. CPC G06Q 20/227; G06K 19/07707; G06Q 20/40; G06Q 20/34
USPC 705/41; 235/488

(57) ABSTRACT

The MULTIPLE ACCOUNT DYNAMIC CARD APPARATUSES, METHODS AND SYSTEMS (“MADC”) may be a flexible payment device where a first flexible layer has two sides—a back side, which includes a data varying loader element and an inner side opposite back side. The inner side may have a power source, circuit, processor, memory, and a graphics processor. An indication is obtained to display the one card account and accompanying graphics and card information and loaded onto the loader element. A display controller is also connected to the processor and controls the display. The transaction card second flexible layer has two sides, one of which is a touch e-ink display and an inner touch e-ink side.

### PRIORITY CLAIM

This application claims priority to U.S. patent application Ser. No. 61/800,909, filed Mar. 15, 2013 and entitled “Multiple Account Dynamic Card Apparatuses, Methods and Systems,” Attorney Docket 517US01. The entire contents of the aforementioned applications are expressly incorporated by reference herein. The entire contents of the aforementioned applications are expressly incorporated by reference herein.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address credit card payments, and more particularly, include MULTIPLE ACCOUNT DYNAMIC CARD APPARATUSES, METHODS AND SYSTEMS.

### BACKGROUND

Consumers make purchases on credit and debit cards. A consumer may purchase any number of goods and services using a credit or debit card in stores, by, for instance, swiping the card, and on the Internet, by, for example, by inputting his or her credit card number.

### SUMMARY

In accordance with the teachings provided herein, systems, methods, non-transitory computer-readable medium, and apparatuses are disclosed for operation upon data processing devices for providing a flexible payment device. For example, a flexible payment device includes:
a transaction card first flexible layer having two sides, including:
   a back side including a data varying loader element;
   an inner side opposite the back side, the inner side having:
      a power source;
      a communicative conduit circuit connected to the power source and to the data varying loader element;
      a processor connected to the communicative conduit circuit;
      a memory connected to the processor, the memory including:
      at least one card account and accompanying card account graphics and card account information, and
      instructions to:
      obtain indication to display the one card account and accompanying card account graphics and card account information, and
      load the card account information to the data varying loader element;
      a display controller connected to the processor, the display controller having a display connector to control a display; and
a transaction card second flexible layer having two sides, including:
   an touch e-ink display side having an e-ink touch display, and
   an inner touch e-ink side having an touch e-ink display and control connector controlling the touch e-ink display, the touch e-ink display and control connector disposed in communication to the display connector.

As another example, a multi-account dynamic payment card processor-implemented method is described herein and can be configured for:
receiving a dynamic payment card pairing request;
effecting a dynamic payment card pairing package to create a pairing connection, wherein the pairing connection involves a dynamic payment card;
sending a dynamic payment card generation request;
receiving a wallet account injection request to inject at least one wallet account into the dynamic payment card;
receiving a wallet account injection confirmation, wherein the wallet account injection confirmation includes at least one wallet account identifier associated with the at least one wallet account; and
transmitting the at least one wallet account identifier to the dynamic payment card.

Other features can include the card receiving information over multiple mechanisms, including Bluetooth, WiFi, and through the contact chip. The card can be configured to display who made a transaction on a specific account as well as the ability to set spending limits on specific accounts by a user. A website may set the spending limit but the spending limit is managed in the card.

As additional examples, systems, methods, apparatuses, and non-transitory computer-readable medium can be configured, such as a multi-account dynamic payment card for:
receiving, by using one or more processors, a dynamic payment card pairing request;
effecting, by using the one or more processors, a dynamic payment card pairing package to create a pairing connection, wherein the pairing connection involves a dynamic payment card;
sending, by using the one or more processors, a dynamic payment card generation request;
receiving, by using the one or more processors, a wallet account injection request to inject at least one wallet account into the dynamic payment card;
receiving, by using the one or more processors, a wallet account injection confirmation, wherein the wallet account injection confirmation includes at least one wallet account identifier associated with the at least one wallet account; and
transmitting, by using the one or more processors, the at least one wallet account identifier to the dynamic payment card.

As further examples, systems, methods, apparatuses, and non-transitory computer-readable medium can be configured, such as a multi-account dynamic payment card for:
instantiating a dynamic payment card application on a mobile device;
receiving a dynamic payment card pairing request;
effecting a dynamic payment card pairing package to create a pairing connection, wherein the pairing connection involves a dynamic payment card;
retrieving, on the mobile device, payment card data associated with at least one payment account;
receiving a payment account injection request to inject the at least one payment account into the dynamic payment card; and
transmitting the retrieved payment card data to the dynamic payment card.

As additional examples, systems, methods, apparatuses, and non-transitory computer-readable medium can be configured, such as a multi-account dynamic payment card for:
instantiating a dynamic payment card application on a mobile device;
receiving, on the mobile device, payment card data associated with at least one payment account;
transmitting a dynamic payment card authentication request associated with the at least one payment account;
receiving a dynamic payment card authentication confirmation message; and
transmitting the received payment card data to a dynamic payment card.

Any of the aforementioned features and limitations may be used in combination with each other and with methods, systems, apparatuses, and computer-readable medium implementations described herein.

### BRIEF DESCRIPTION OF THE DRAWINGS

The accompanying appendices and/or drawings illustrate various non-limiting, example, innovative aspects in accordance with the present descriptions:

FIG. 1 shows a block diagram illustrating a consumer use example embodiment of the MADC;

FIG. 2 shows a block diagram illustrating an embodiment of the components of the MADC;

FIG. 3 shows a block diagram illustrating an embodiment of the swiping of the MADC;

FIG. 4 shows a block diagram illustrating various example screenshot embodiments of the MADC;

FIG. 5 shows a block diagram illustrating an example embodiment of a mobile application for the MADC;

FIG. 6 shows a data flow diagram illustrating data flows while setting up a new card in various embodiments of the MADC;

FIG. 7 shows a data flow diagram illustrating data flows while completing a transaction in various embodiments of the MADC;

FIG. 8 is a logic flow diagram showing an embodiment of log in and account creation component of the MADC;

FIG. 9 is a logic flow diagram illustrating an embodiment of adding new cards component of the MADC;

FIG. 10 shows a logic flow diagram of an example transaction component of the MADC;

FIG. 11 shows a logic flow diagram of an embodiment of updating card data component of the MADC; and

FIG. 12 shows a block diagram illustrating embodiments of a MADC controller;

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Introduction

The Multiple Account Dynamic Card may be a payment card with a changeable display. The MADC may be the overall size of a typical credit card and may store information for multiple credit and/or debit cards, gift cards, and/or the like. This information may be one or more of: card issuer information, a card logo, the logo of the credit card company, the name of the user, the credit card number, the expiration date, the user's signature, and/or the like. In some embodiments, the MADC display uses e-Ink to display some or all of the stored information, such as that which would normally appear on a regular credit card. For example, the display may show card issuer information, a card logo, the logo of the credit card company, the name of the user, the credit card number, the expiration date, and/or the like. In some implementations, only the front of the MADC is a changeable display. In another embodiment, both the front and rear sides of the MADC are changeable. In alternative embodiments, only part of the front and/or rear display is changeable, while other parts remain static. For example, these static portions may be plastic, metal and/or the like.

In some embodiments, a user may load several cards on the MADC. For example, the MADC may store information for multiple credit and/or debit cards for one or more users. In one implementation, the user may push a button to switch between cards and/or users. Some implementations have one button to switch cards and separate button to switch between users. Other implementations use a single button. In another embodiment, a user may use swipe commands to change between cards. For example, the MADC may have a touch screen that allows a user to swipe and/or tap to change cards. For instance, a user may be viewing and using a debit card, but wish to make a purchase with a credit card. In the various embodiments described above, the user may push a button, swipe one or more fingers across the screen of the MADC, or tap a side and/or corner of the card one or more times to change cards.

In some embodiments, the changeable display may also display further information such as current balances, which may be either balance of the credit card or the bank account to which the card is linked. A customer service number may also be provided, as well as any card-specific information. Further, the card may include a GPS chip, or may read location-based information from another source. This may be used to find location-specific offers, such as coupon codes, or special deals for sponsored retailers and/or restaurants. In an alternative embodiment, the offers may be randomized or region-specific based on user account information. For example, a user may indicate that he or she lives in New York City in a user account. This information may be used to communicate offers specific to New York City to the MADC. Additionally, if the user indicates to his or her credit and/or debit card company that he or she is traveling, this information may be used to send offers for the city to which the cardholder is traveling. For example, a New York user who is traveling to London for business may notify his or her credit card companies and the issuer of MADC. Offers for goods and services in London may then be sent to the resident New Yorker, who usually receives New York offers, for the days that he or she is traveling in London.

In some implementations, the MADC may be able to analyze the financial data available on all cards loaded in the system and recommend a particular card to the consumer for a particular transaction. This analysis may involve comparing which accounts have been paid recently, if there are any gift cards that are generic or for a particular merchant that can be used, how close the balance on a card is to its credit limit, etc.

### MADC

FIG. 1 shows a block diagram illustrating consumer use embodiments of the MADC. A user 105 reaches into his or her wallet to retrieve a credit card 110, and realizes that the credit card he or she wishes to use for the transaction is not in the wallet. A user 115 uses the MADC 120. When he or she pulls the MADC 120 out of his or her wallet, and wants to use a certain card, he or she can choose which card he or she wants to use while only carrying one card. The user 115 may initially view his debit card 125 on the MADC 120, but wishes instead to use a certain credit card, Credit Card 1, 130. The user may use an interface 135, such as a button, touch screen, or the like, to change the card being used.

FIG. 2 displays a block figure diagram of an example embodiment of the components of the MADC. The dynamic display layer card front 205 may have a changeable display, such as e-Ink. The front of the card may display card information, logo information, card company information, the user's name, expiration date, the credit card number and/or the like. In some implementations, the card is uses an RFID chip 230 on the front face of the card. In some embodiments, a clear protective cover, such as one used in 3M Natural View Screen Protectors, may be affixed to the front of the dynamic display layer 205. The card back 210, may also have a changeable display, such as e-Ink. In some implementations, a clear protective cover may protect the back layer, as well. In some embodiments, the card front 205 and the card back 210 are flexible, such that it may bend slightly in a user's wallet. For example, this may be achieved by using e Ink's flexible display that uses plastic-based thin-film transistor (TFT) backplanes. Between the card front and the card back are various components including an insulator layer 245, which may be a double-stick adhesive version of the 3M Natural View Screen Protector. For example, a processor chip 215, a display controller 220, leeds 225 and a battery 230 might be included. The processor chip 215 may be a system on a chip processor that may include a microprocessor, memory, timing sources, power management, a cellular radio, Bluetooth radio, and/or the like. The processor chip 215 may be a Qualcomm Snapdragon S4, NVIDIA Tegra 3, Samsung Exynos Processor, Intel Medfield, Texas Instrucments OMAP4, and/or the like. The display controller 220 may be an Epson S1D13521 EPD Controller, and the battery 235 may be a micro-battery, such as a watch battery, like a Sony SR410SW, a lithium ion battery, and/or the like.

FIG. 3 depicts the dynamic card front of the MADC before swiping 305. In this example, the first card displayed is from Bank XYZ. The user then swipes the card to the left using his finger 315. As can be seen from the drawing, the card from Bank XYZ is sliding to the left, while a new card enters from the right. After the user swipes the card at 315, the dynamic card front shows a new card 320, this time from Bank ABC. In some embodiments, the user may swipe his or her finger to the left or to the right. In some implementations, a preferred order is set for the cards to appear. For example, if the card from Bank XYZ is the one the user uses most frequently, he may want the MADC to keep that card queued next if it is not being displayed. This way, for example, the next time the user swipes his MADC the card from Bank XYZ would display. In other implementations, the cards may have a set rotation. That is, in the example shown in FIG. 3, if the user swiped back to the right after using the card from Bank ABC, the card from Bank XYZ would appear, whereas if the user swiped to the left again a third card would appear, assuming the user has at least three cards loaded.

FIG. 4 displays a example screenshots of various embodiments of the MADC. For example, a sample card front 405 shows a chip card that includes an RFID chip 410, as well as card-specific information. The MADC may also display instructions to “Swipe ← to change card” 415. In this sample implementation, the display may be a touch screen, such that user may swipe his or her finger across the screen to change to the next card. In alternative embodiments, the user may be asked to tap the screen. For example, the user may tap the right edge to change to the next card or the left edge to change to the previous card. In yet another embodiment, a user may just tap the screen, for example, by double tapping the screen, to rotate between the cards. Instructions for each of these may be displayed on the front of the card 415.

A sample card back 420 shows an example display 425. In one embodiment, the card back 420 displays the current balance on the card. In some embodiments, this may be the current balance of charges on that particular credit card in that billing cycle. In other embodiments, it may be the remaining balance under the credit limit for the particular card, the balance of the user's checking account, the balance remaining on a gift card, and/or the like. The card back 420 may also show the customer service number for that particular card, the customer service number for the MADC, and/or the like. An offer may also be presented on the card back 420. This offer may be location-specific. For example, the user may have a user account with the MADC that indicates that the user lives in New York City. The MADC may present offers that are specifically geared towards goods and/or services in the New York metropolitan area. In another embodiment, the MADC may use location-based services, such as GPS, a local IP address, and/or the like to identify the location of the MADC and use this information to send location-specific offers to the MADC. Alternative embodiments may use user-specific information to present offers that may interest the user. The card back may also display information on the last transaction charged to the card. For example, the card may displayed that the last transaction on that particular card, such as a coffee purchase an hour ago at Dunkin Donuts for $1.99.

Additionally, sample card back 420 shows a magnetic card strip 460 which is present in one embodiment of the MADC. This may be used in addition to or as an alternative to the RFID 410. The information on the magnetic strip 460 or on the RFID chip 410 may change depending on which card is being used. For example, when the user changes which card he or she is using, the information on the magnetic strip 460 or RFID chip 420 may change to correspond to the card currently displayed by the MADC. This changeable magnetic strip may be similar to the re-magnetization features discussed in the article http://www.dvice.com/archives/2011/01/all-your-differ.php.

Sample card back 430 shows an alternative embodiment that displays the current balance, customer service, and an offer, as discussed above 425. Sample card back 430 may also have at least one button. The example embodiment shown in 430 has two buttons—one button to change the card being used by the user 435, and another button to change the user of the card 440. Some embodiments may have only a change card button 435, while others may have only a change user button 440, and others may have both 435 and 440.

In embodiments where a change user button 440 is present, additional security measures may be used, such as a fingerprint reader, signature display, and/or the like. In embodiments with a touch screen, the touch screen may be used to read a finger print. In alternative embodiments, a fingerprint reader may be added to the MADC. Other implementations may also display a pre-stored signature line with each user's signature or may ask a user to input a special code. In another embodiment where the MADC uses a touchscreen, the MADC may require each user to input a touch-location-based password where, for example, a user may confirm that he or she is the proper user by touching the corners in a certain series. For example, a first user may use the following series: top-left, top-right, top-right, bottom-left while the other user may use: center, top-left, top-right, center.

Sample card back 445 shows an alternative implementation that shows current balance, customer service, and the last transaction, as well as the buttons to change card and user. In some embodiments, the display may be updated using buttons and/or the touch screen to show a different set of options. Alternatively, some embodiments may allow a user to cycle through several available offers or cycle through his or her most recent transactions. For example, in one embodiment, the MADC may display up to the last 10 transactions made using the card.

FIG. 5 shows an example embodiment of a mobile phone application that connects to the MADC. Through the mobile app, a user may be able up add a card to his or her account, update his or her account data, retrieve new offers, update the MADC, and access additional functionality of the MADC. This may also provide enhanced security for the user, as it may be used to keep a rotating pin in order to use the MADC. For example, a user may keep several cards on the MADC, but only the debit card requires that he input a pin. The mobile MADC app may provide a rotating pin number for the user to input with all of his cards loaded on the MADC. Additionally, the mobile app may allow the phone to be used to communicate with the server. In one implementation, the MADC has Bluetooth technology built in, which allows for local network connections. The Bluetooth technology may allow the card to connect to the user's mobile phone, and the mobile phone may be able to communicate with the server. This may also provide enhanced offer capabilities, as the location of the cell phone can be used to push offers to the user based on the user's location. This also may allow users to keep their account updated on-the-go. For example, a user may receive a gift card from a friend while out to dinner celebrating the user's birthday. Instead of having to keep track of a gift card and carry another card in his or her wallet, the user may add the gift card to the MADC directly from his or her mobile phone using the app. Similar functionality may also be available using a computer network.

FIG. 6 shows a data flow diagram illustrating data flows while setting up a new card in various embodiments of the MADC. A user 602 may set up his or her MADC. In some implementations, this may be done on a device such as a computer, while in other embodiments this may be done on a mobile telephone, tablet computer, and/or the like 604. The user may load his wallet onto his device 605 and request that his device enter pairing mode 610. The phone enters pair mode 612, and the user may then engage pair mode on the MADC 615 and the device and MADC pair 617. and register the MADC with the wallet 620 with the server 606. The server may then register the MADC and look up the user's wallet account information 625 and send an authentication message to load the account on the MADC 630. In some implementations, an exemplary XML-encoded command message 208 may take a form similar to the following:

```
11 POST /Wallet_Account_Authentication_Message.php HTTP/1.1
12 Host: www.DCMCPproccess.com
13 Content-Type: Application/XML
14 Content-Length: 788
15 <?XML version = “1.0” encoding = “UTF-8”?>
16 < Wallet_Account_Authentication_Message>
17  <Card_1>
18  <Card_Type> Visa </Card_Type.
19  <Issuer_ID> Bank X </Issuer_ID>
20  <PAN> 4123456789101112 </PAN>
21  <Expiration_Date> 12-2014 </Expiration_Date>
22  <User_Name> John Doe </User_Name>
23  <CCV> 123 </CCV>
24  <Limit> $5,000 </Limit>
25  <Balance> $1,500 </Balance>
26  <UserPhoto>
27  <image_info>
28  <name> gesture1 </name>
29  <format> JPEG </format>
30  <compression> JPEG compression </compression>
  1  <size> 123456 bytes </size>
  2  <x-Resolution> 72.0 </x-Resolution>
  3  <y-Resolution> 72.0 </y-Resolution>
  4  <date_time> 2014:8:11 16:45:32 </date_time>
  5  <color>greyscale</color>
  6  ...
  7  <content> ÿØÿà JFIF  H H  ÿâ\acute{ } ICC_PROFILE  ¤appl
  8  mntrRGB XYZ  Ü $  acspAPPL öÖÓ-appl
  9  desc  P  bdscm  \acute{ } \check{S}cprt  @
10  $wtpt  d  rXYZ
11  x  gXYZ
12 [symbol]    bXYZ
13  rTRC
14  \acute{ } aarg  À vcgt ...
15  </content>
16  ...
17  </image_info>
18  </UserPhoto>
19  <Graphic>
20  <image_info>
21  <name> gesture1 </name>
22  <format> JPEG </format>
23  <compression> JPEG compression </compression>
24  <size> 123456 bytes </size>
25  <x-Resolution> 72.0 </x-Resolution>
26  <y-Resolution> 72.0 </y-Resolution>
27  <date_time> 2014:8:11 16:45:32 </date_time>
28  <color>greyscale</color>
29  ...
30  <content> ÿØÿà JFIF  H H  ÿâ\acute{ } ICC_PROFILE  ¤appl
31  mntrRGB XYZ  Ü $  acspAPPL öÖÓ-appl
32  desc  P  bdscm  \acute{ } \check{S}cprt  @
  1  $wtpt  d  rXYZ
  2  x  gXYZ
  3 [symbol]    bXYZ
  4  rTRC
  5  \acute{ } aarg  À vcgt ...
  6  </content>
  7  ...
  8  </image_info>
  9  </Graphic>
10  <SignatureGraphic>
11  <image_info>
12  <name> gesture1 </name>
13  <format> JPEG </format>
14  <compression> JPEG compression </compression>
15  <size> 123456 bytes </size>
16  <x-Resolution> 72.0 </x-Resolution>
17  <y-Resolution> 72.0 </y-Resolution>
18  <date_time> 2014:8:11 16:45:32 </date_time>
19  <color>greyscale</color>
20  ...
21  <content> ÿØÿà JFIF  H H  ÿâ\acute{ } ICC_PROFILE  ¤appl
22  mntrRGB XYZ  Ü $  acspAPPL öÖÓ-appl
23  desc  P  bdscm  \acute{ } \check{S}cprt  @
24  $wtpt  d  rXYZ
25  x  gXYZ
26 [symbol]    bXYZ
27  rTRC
28  \acute{ } aarg  À vcgt ...
29  </content>
30  ...
31  </image_info>
32  </SignatureGraphic>
  1  </Card_1>
  2  <Card_2>
  3  <Card_Type> MasterCard </Card_Type.
  4  <Issuer_ID> Bank Y </Issuer_ID>
  5  <PAN> 4987654321098765 </PAN>
  6  <Expiration_Date> 6-2015 </Expiration_Date>
  7  <User_Name> Jane Consumer </User_Name>
  8  <CCV> 987 </CCV>
  9  <Limit> $10,000 </Limit>
10  <Balance> $3,600 </Balance>
11  <UserPhoto>
12  <image_info>
13  <name> gesture1 </name>
14  <format> JPEG </format>
15  <compression> JPEG compression </compression>
16  <size> 123456 bytes </size>
17  <x-Resolution> 72.0 </x-Resolution>
18  <y-Resolution> 72.0 </y-Resolution>
19  <date_time> 2014:8:11 16:45:32 </date_time>
20  <color>greyscale</color>
21  ...
22  <content> ÿØÿà JFIF  H H  ÿâ\acute{ } ICC_PROFILE  ¤appl
23  mntrRGB XYZ  Ü $  acspAPPL öÖÓ-appl
24  desc  P  bdscm  \acute{ } \check{S}cprt  @
25  $wtpt  d  rXYZ
26  x  gXYZ
27 [symbol]    bXYZ
28  rTRC
29  \acute{ } aarg  À vcgt ...
30  </content>
31  ...
32  </image_info>
33  </UserPhoto>
34  <Graphic>
  1  <image_info>
  2  <name> gesture1 </name>
  3  <format> JPEG </format>
  4  <compression> JPEG compression </compression>
  5  <size> 123456 bytes </size>
  6  <x-Resolution> 72.0 </x-Resolution>
  7  <y-Resolution> 72.0 </y-Resolution>
  8  <date_time> 2014:8:11 16:45:32 </date_time>
  9  <color>greyscale</color>
10  ...
11  <content> ÿØÿà JFIF  H H  ÿâ\acute{ } ICC_PROFILE  ¤appl
12  mntrRGB XYZ  Ü $  acspAPPL öÖÓ-appl
13  desc  P  bdscm  \acute{ } \check{S}cprt  @
14  $wtpt  d  rXYZ
15  x  gXYZ
16 [symbol]    bXYZ
17  rTRC
18  \acute{ } aarg  À vcgt ...
19  </content>
20  ...
21  </image_info>
22  </Graphic>
23  <SignatureGraphic>
24  <image_info>
25  <name> gesture1 </name>
26  <format> JPEG </format>
27  <compression> JPEG compression </compression>
28  <size> 123456 bytes </size>
29  <x-Resolution> 72.0 </x-Resolution>
30  <y-Resolution> 72.0 </y-Resolution>
31  <date_time> 2014:8:11 16:45:32 </date_time>
32  <color>greyscale</color>
  1  ...
  2  <content> ÿØÿà JFIF  H H  ÿâ\acute{ } ICC_PROFILE  ¤appl
  3  mntrRGB XYZ  Ü $  acspAPPL öÖÓ-appl
  4  desc  P  bdscm  \acute{ } \check{S}cprt  @
  5  $wtpt  d  rXYZ
  6  x  gXYZ
  7 [symbol]    bXYZ
  8  rTRC
  9  \acute{ } aarg  À vcgt ...
10  </content>
11  ...
12  </image_info>
13  </SignatureGraphic>
14  </Card_2>
15  ...
16 </Wallet_Account_Authentication_Message>
```

The cards may sync with the user's device, and the user may select which cards he or she wishes to load onto the MADC 635. The device may then send the cards to the MADC 640, and the sync may be confirmed 645 and the cards may be instantiated 650. In some embodiments, the cards may be loaded directly to the MADC directly from the server without using the device. In alternative embodiments, when the registration request is sent to the server 620 and the authentication message sent 630, the cards may automatically load onto the MADC.

FIG. 7 shows a data flow diagram illustrating data flows while completing a transaction in various embodiments of the MADC. A user 702 selects a card to use 705. As discussed above, this may be done several ways, such as using a touch screen to swipe or tap between cards or using a button. The MADC retrieves and loads the card image, card number, security code (CCV), expiration date, and the like and loads the card image, along with the relevant data, onto the MADC 710. The transaction data may then be sent to the server 715, and the merchant server may process the transaction data 720. The server may send indication that the selected card has been verified and completed 725.

FIG. 8 shows a user wallet log in and account creation component of the MADC. A user may request to sync wallet data with his or her MADC 805. A user may log into their wallet account or create a new account upon receiving the MADC. A user may also manage his or her account by logging into his or her MADC account. This may be done on a computer or mobile device, such as a tablet computer or mobile telephone. The login or create account screen may be displayed to the client 810, where the user may supply input in the form of either his or her login information or an indication that he or she wishes to create a new account 815. If the user indicates he or she wants to create an account 820, an editable web form 825 may be supplied to the user, and the user may enter account information, including a username, password, address, email address, and/or the like 830. This information may also include a serial number or other identifying indicia from the user's MADC to be used in the registration process. The server may then determine whether the information entered is valid 845. If so, the server may store the newly created account information in the user accounts database 1219. If not, the error handler 840 may be activated. If the user has an account, the server may determine whether login input received 835. If the server determines that the account is not valid or was entered incorrectly 845, the error handler 840 is activated. If the user did input login information 835, the server may determine whether the login information was valid, and the server may retrieve account information 840, including user wallet data, from database 1219. Account information may be retrieved 850 and a user account information or user options screen may be generated 860 and displayed 870 on the user device. The user may provide option selection information 880. In one embodiment, the option selection information may be the user indicating which cards he or she wishes to load onto his or her MADC. The server may then provide updated account information to the MADC 885.

FIG. 9 shows an example embodiment of adding new cards to a MADC. A display page may be shown to a user 910 and a user may indicate that he or she would like to add a new card to his or her account 915. The server may determine whether a valid input has been received 920. If not, the error handler 925 may be activated. If so, the server may generate a display to add a new card to the user's account 930. This screen may be displayed 935 and a user may input his or her card information 940. The server may determine whether this information is valid, for example, by verifying the number of digits in the credit card number, the user's address, and/or the like. If the information is determined not to be valid, the error handler 925 is activated. If the information is valid, the server may generate a confirmation screen 950. The confirmation screen may include a button or another way for the user to indicate that he or she wishes to add an additional card 955 and the user may provide this input 960. If the user indicates that he or she wishes to add a new card 965, the server may generate a new card screen 930 and the process may continue again from there. If the user does not indicate that he or she wishes to enter a new card 965, the server may send the new card information to the MADC 970. If the user enters multiple cards, the server may send the new information to the MADC individually or in a batch mode. Notifications may be sent in the form of push notifications over a cellular network, or, in some instances, might use Bluetooth technology to link to a user's cell phone, and the mobile phone would push the update to the card via Bluetooth.

Similarly, if a user wishes to remove a card, a similar process may be followed. The welcome screen may be displayed 910 and the user provides input that he or she wishes to remove a card from the MADC 915. The server may validate this input 920 and, if the user input is not valid, the error handler may be activated 925. If the user input is valid, the server may generate a remove card screen 930 and receive user input 940. This user input may include, for example, the card that the user wishes to remove. If the input is not valid, the error handler 925 may be activated, but if it is valid, the server may generate a confirmation screen 950 and display the screen 955 to the user. In some embodiments, the confirmation for card removal may also include an inquiry as to whether the user wishes to add a new card, for example, to replace the card being removed 950. The user may supply information that he or she wishes to add a new card 960, and if so, the server generates a new card screen 930 and the process discussed above may proceed. If the user does not wish to add a new card, the server may send a delete indicia, using, for example, push notifications, to the card from the MADC 970. In one embodiment, the MADC may automatically remove cards that have expired.

FIG. 10 shows an example transaction component of the MADC. A user may be at a retailer, for example, and provide indication that he or she would like to change the card on the MADC 1010. The MADC may then retrieve the next card 1012 and load the new card 1014. The user may then swipe the card at a terminal at a retailer 1015. Similarly, the user may use the card online by entering the card number, for example. The transaction data is received at the server 1020 and the server may determine whether the transaction data is valid 1025. This validation may test various factors, such as detecting potential fraud, ensuring the user's account is not exceeding the credit limit, verifying that the transaction is not overdrawing the user's debit card account, and/or the like. If the validation results in the transaction being approved, the server may generate an approval notification 1030 and display at the client that the card transaction has been approved 1035, thereby ending the process. If the transaction is not validated 1025, the server may generate a rejection notification 1040 and may suggest that the user try a different card stored on the MADC 1045. The user may then decide if he or she wishes to try a new card, in which case the process may restart at 1010 as the user may select a new card on the MADC. If the user opts not to try a new card, the process may end 1060.

FIG. 11 shows an embodiment of updating or changing data displayed and stored the MADC. In one embodiment, a user may request to change cards on the MADC 1110. In an alternative embodiment, the user may request that the information on the current card displayed is updated 1110. The user may make this request by using a swipe or tap command on a touch screen, or using various buttons on the MADC. For example, a user may swipe his or her finger left or right to change the card to the next or previous card stored on the MADC. Alternatively, the user may tap the left or right edge for a similar result. Swiping and tapping may also be used to request an update on the card currently displayed. In another embodiment, the user may push a button to change cards or to update the card account data.

This request may be sent to the server, which may receive the request for card account data 1115. The card account data requested may be the account number, current balance of the account, recent transactions on the card, and/or the like. In another embodiment, the card account data retrieved may also include offers for local deals, deals targeted for the user, or generic deals available to MADC users. The server may generate a query to retrieve updated card account data 1120 and, if necessary, may retrieve the information from a third party client/server. For example, if the card is a debit card associated with Bank X, the server may generate a query to retrieve the balance of the user's bank account at Bank X. In an alternative embodiment, the server may have direct access to this information and may be able to retrieve it from a database 1219. If the server retrieves the information from a third party, it may update the card account data 1130 and store this information in database 1219. The server may generate a notification with updated card account data 1135, which may be sent to the MADC. The MADC may display the updated card account data 1130.

### MADC Controller

FIG. 12 shows a block diagram illustrating embodiments of a MADC controller. In this embodiment, the MADC controller 1201 may serve to aggregate, process, store, search, serve, identify, instruct, generate, match, and/or facilitate interactions with a computer through mobile account dynamic card technologies, and/or other related data.

Typically, users, which may be people and/or other systems, may engage information technology systems (e.g., computers) to facilitate information processing. In turn, computers employ processors to process information; such processors 1203 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 1229 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the MADC controller 1201 may be connected to and/or communicate with entities such as, but not limited to: one or more users from user input devices 1211; peripheral devices 1212; an optional cryptographic processor device 1228; and/or a communications network 1213.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The MADC controller 1201 may be based on computer systems that may comprise, but are not limited to, components such as: a computer systemization 1202 connected to memory 1229.

### Computer Systemization

A computer systemization 1202 may comprise a clock 1230, central processing unit (“CPU(s)” and/or “processor(s)” (these terms are used interchangeable throughout the disclosure unless noted to the contrary)) 1203, a memory 1229 (e.g., a read only memory (ROM) 1206, a random access memory (RAM) 1205, etc.), and/or an interface bus 1207, and most frequently, although not necessarily, are all interconnected and/or communicating through a system bus 1204 on one or more (mother)board(s) 1202 having conductive and/or otherwise transportive circuit pathways through which instructions (e.g., binary encoded signals) may travel to effectuate communications, operations, storage, etc. The computer systemization may be connected to a power source 1286; e.g., optionally the power source may be internal. Optionally, a cryptographic processor 1226 and/or transceivers (e.g., ICs) 1274 may be connected to the system bus. In another embodiment, the cryptographic processor and/or transceivers may be connected as either internal and/or external peripheral devices 1212 via the interface bus I/O. In turn, the transceivers may be connected to antenna(s) 1275, thereby effectuating wireless transmission and reception of various communication and/or sensor protocols; for example the antenna(s) may connect to: a Texas Instruments WiLink WL1283 transceiver chip (e.g., providing 802.1 in, Bluetooth 3.0, FM, global positioning system (GPS) (thereby allowing MADC controller to determine its location)); Broadcom BCM4329FKUBG transceiver chip (e.g., providing 802.1 in, Bluetooth 2.1+EDR, FM, etc.); a Broadcom BCM47501UB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 1229 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the MADC controller and beyond through various interfaces. Should processing requirements dictate a greater amount speed and/or capacity, distributed processors (e.g., Distributed MADC), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the MADC may be achieved by implementing a microcontroller such as CAST's R8051XC2 microcontroller; Intel's MCS 51 (i.e., 8051 microcontroller); and/or the like. Also, to implement certain features of the MADC, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the MADC component collection (distributed or otherwise) and/or features may be implemented via the microprocessor and/or via embedded components; e.g., via ASIC, coprocessor, DSP, FPGA, and/or the like. Alternately, some implementations of the MADC may be implemented with embedded components that are configured and used to achieve a variety of features or signal processing.

Depending on the particular implementation, the embedded components may include software solutions, hardware solutions, and/or some combination of both hardware/software solutions. For example, MADC features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the MADC features. A hierarchy of programmable interconnects allow logic blocks to be interconnected as needed by the MADC system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the MADC may be developed on regular FPGAs and then migrated into a fixed version that more resembles ASIC implementations. Alternate or coordinating implementations may migrate MADC controller features to a final ASIC instead of or in addition to FPGAs. Depending on the implementation all of the aforementioned embedded components and microprocessors may be considered the “CPU” and/or “processor” for the MADC.

### Power Source

The power source 1286 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1286 is connected to at least one of the interconnected subsequent components of the MADC thereby providing an electric current to all subsequent components. In one example, the power source 1286 is connected to the system bus component 1204. In an alternative embodiment, an outside power source 1286 is provided through a connection across the I/O 1208 interface. For example, a USB and/or IEEE 1394 connection carries both data and power across the connection and is therefore a suitable source of power.

### Interface Adapters

Interface bus(ses) 1207 may accept, connect, and/or communicate to a number of interface adapters, conventionally although not necessarily in the form of adapter cards, such as but not limited to: input output interfaces (I/O) 1208, storage interfaces 1209, network interfaces 1210, and/or the like. Optionally, cryptographic processor interfaces 1227 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1209 may accept, communicate, and/or connect to a number of storage devices such as, but not limited to: storage devices 1214, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1210 may accept, communicate, and/or connect to a communications network 1213. Through a communications network 1213, the MADC controller is accessible through remote clients 1233b (e.g., computers with web browsers) by users 1233a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed MADC), architectures may similarly be employed to pool, load balance, and/or otherwise increase the communicative bandwidth required by the MADC controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1210 may be used to engage with various communications network types 1213. For example, multiple network interfaces may be employed to allow for the communication over broadcast, multicast, and/or unicast networks.

Input Output interfaces (I/O) 1208 may accept, communicate, and/or connect to user input devices 1211, peripheral devices 1212, cryptographic processor devices 1228, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 1211 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 1212 may be connected and/or communicate to I/O and/or other facilities of the like such as network interfaces, storage interfaces, directly to the interface bus, system bus, the CPU, and/or the like. Peripheral devices may be external, internal and/or part of the MADC controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the MADC controller may be embodied as an embedded, dedicated, and/or monitor-less (i.e., headless) device, wherein access would be provided over a network interface connection.

Cryptographic units such as, but not limited to, microcontrollers, processors 1226, interfaces 1227, and/or devices 1228 may be attached, and/or communicate with the MADC controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 1229. However, memory is a fungible technology and resource, thus, any number of memory embodiments may be employed in lieu of or in concert with one another. It is to be understood that the MADC controller and/or a computer systemization may employ various forms of memory 1229. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 1229 will include ROM 1206, RAM 1205, and a storage device 1214. A storage device 1214 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 1229 may contain a collection of program and/or database components and/or data such as, but not limited to: operating system component(s) 1215 (operating system); information server component(s) 1216 (information server); user interface component(s) 1217 (user interface); Web browser component(s) 1218 (Web browser); database(s) 1219; mail server component(s) 1221; mail client component(s) 1222; cryptographic server component(s) 1220 (cryptographic server); the MADC component(s) 1235; and/or the like (i.e., collectively a component collection). These components may be stored and accessed from the storage devices and/or from storage devices accessible through an interface bus. Although non-conventional program components such as those in the component collection, typically, are stored in a local storage device 1214, they may also be loaded and/or stored in memory such as: peripheral devices, RAM, remote storage facilities through a communications network, ROM, various forms of memory, and/or the like.

### Operating System

The operating system component 1215 is an executable program component facilitating the operation of the MADC controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the MADC controller to communicate with other entities through a communications network 1213. Various communication protocols may be used by the MADC controller as a subcarrier transport mechanism for interaction, such as, but not limited to: multicast, TCP/IP, UDP, unicast, and/or the like.

### Information Server

An information server component 1216 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the MADC controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the MADC database 1219, operating systems, other program components, user interfaces, Web browsers, and/or the like.

Access to the MADC database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the MADC. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the MADC as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 1217 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 1218 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the MADC enabled nodes. The combined application may be nugatory on systems employing standard Web browsers.

### Mail Server

A mail server component 1221 is a stored program component that is executed by a CPU 1203. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the MADC.

Access to the MADC mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 1222 is a stored program component that is executed by a CPU 1203. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 1220 is a stored program component that is executed by a CPU 1203, cryptographic processor 1226, cryptographic processor interface 1227, cryptographic processor device 1228, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the MADC may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the MADC component to engage in secure transactions if so desired. The cryptographic component facilitates the secure accessing of resources on the MADC and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The MADC Database

The MADC database component 1219 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the MADC database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the MADC database is implemented as a data-structure, the use of the MADC database 1219 may be integrated into another component such as the MADC component 1235. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1219 includes several tables 1219a-f. A user table 1219a includes fields such as, but not limited to: a User_ID, firstname, lastname, address, dob, zipcode, account_type, account_expiration, and/or the like. The user table may support and/or track multiple entity accounts on a MADC. A client accounts table 1219b includes fields such as, but not limited to: client_ID, client_type, client_clientusers, and/or the like. The offer accounts table 1219c includes fields such as, but not limited to, offer_ID, offer_city, offer_quantity, offer_targetaudience, and/or the like. The transaction data table 1219d includes fields such as but not limited to transaction_ID, cost, merchant, itemspurchased, and/or the like. The user account data table 1219e includes fields such as, but not limited to UserAccount_ID, transaction, purchase, city, merchant, and/or the like. The graphics data table 1219f includes fields such as, but not limited to Graphics_ID, UserPhoto, SignatureGraphic, Graphic, and/or the like.

In one embodiment, the MADC database may interact with other database systems. For example, employing a distributed database system, queries and data access by search MADC component may treat the combination of the MADC database, an integrated data security layer database as a single database entity.

In one embodiment, user programs may contain various user interface primitives, which may serve to update the MADC. Also, various accounts may require custom database tables depending upon the environments and the types of clients the MADC may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1219a-1219e. The MADC may be configured to keep track of various settings, inputs, and parameters via database controllers.

The MADC database may communicate to and/or with other components in a component collection, including itself, and/or facilities of the like. Most frequently, the MADC database communicates with the MADC component, other program components, and/or the like. The database may contain, retain, and provide information regarding other nodes and data.

### The MADCs

The MADC component 1235 is a stored program component that is executed by a CPU. In one embodiment, the MADC component incorporates any and/or all combinations of the aspects of the MADC that was discussed in the previous figures. As such, the MADC affects accessing, obtaining and the provision of information, services, transactions, and/or the like across various communications networks.

The MADC transforms traditional credit card numbers and user accounts inputs via MADC components log in and account creation, add new cards, transactions, and card updating, into a single multiple account dynamic card output.

The MADC component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the MADC server employs a cryptographic server to encrypt and decrypt communications. The MADC component may communicate to and/or with other components in a component collection, including itself, and/or facilities of the like. Most frequently, the MADC component communicates with the MADC database, operating systems, other program components, and/or the like. The MADC may contain, communicate, generate, obtain, and/or provide program component, system, user, and/or data communications, requests, and/or responses.

### Distributed MADCs

The structure and/or operation of any of the MADC node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the MADC controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c -post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the MADC controller may be executing a PHP script implementing a Secure Sockets Layer (“SSL”) socket server via the information sherver, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header (‘C ontent-Type: text/plain’);
// set ip address and port to listen to for incoming data
$address = ‘192.168.0.100’;
$port = 255;
// create a server-side SSL socket, listen for/accept incoming
communication
$sock = socket_create (AF_INET, SOCK_STREAM, 0);
socket_bind ($sock, $address, $port) or die (‘Could not bind to address’);
socket_listen ($sock);
$client = socket_accept ($sock);
// read input data from client device in 1024 byte blocks until the end of
message do (
      $input = “”;
      $input = socket_read ($client, 1024);
      $data = $input;
) while ($input != “”);
// parse data to extract variables
$obj = json_decode ($data, true);
// store input data in a database
mysql_connect (“201.408.185.132”,$DBserver,$password) ; // access
database server
mysql_selection (“CLIENT_DB. SQL”) ; // select database to append
mysql_query (“INSERT INTO UserTable (transmission)
VALUES ($data)” ); // add data to UserTable table in a CLIENT database
mysql_close (“CLIENT_DB.SQL”); // close connection to database
?>
```

Also, the following resources may be used to provide example embodiments regarding SOAP parser implementation:
http://www.xay.com/perl/site/lib/SOAP/Parser.html
http://publib.boulder.ibm.com/infocenter/tivihelp/v2rl/index.jsp?topic=/com.ibm.IBMDI.doc/referenceguide295.htm
   And other parser implementations:
http://publib.boulder.ibm.com/infocenter/tivihelp/v2rl/index.jsp?topic=com.ibm.IBMDI.doc/referenceguide259.htm
   all of which are hereby expressly incorporated by reference.

In order to address various issues and advance the art, the entirety of this application for MULTIPLE ACCOUNT DYNAMIC CARD APPARATUSES, METHODS AND SYSTEMS (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a MADC individual and/or enterprise user, database configuration and/or relational model, data type, data transmission and/or network framework, syntax structure, and/or the like, various embodiments of the MADC, may be implemented that enable a great deal of flexibility and customization. For example, aspects of the MADC may be adapted for account consolidation, updated security methods, enhanced credit card functionality, and/or the like. While various embodiments and discussions of the MARC have included consolidating multiple credit, debit and/or gift cards onto a single card, however, it is to be understood that the embodiments described herein may be readily configured and/or customized for a wide variety of other applications and/or implementations.

What is claimed is:

1. A flexible payment device, comprising:
a transaction card first flexible layer having two sides, including:
a back side including a data varying loader element;
an inner side opposite the back side, the inner side having:
a power source;
a communicative conduit circuit connected to the power source and to the data varying loader element;
a processor connected to the communicative conduit circuit;
a memory connected to the processor, the memory including:
at least one card account and accompanying card account graphics and card account information, and
instructions to:
obtain indication to display the one card account and accompanying card account graphics and card account information, and
load the card account information to the data varying loader element;
a display controller connected to the processor, the display controller having a display connector to control a display; and
a transaction card second flexible layer having two sides, including:
an touch e-ink display side having an e-ink touch display, and
an inner touch e-ink side having an touch e-ink display and control connector controlling the touch e-ink display, the touch e-ink display and control connector disposed in communication to the display connector.

2. The device of claim 1, wherein the indication to display the one card account is a gesture, and the one card account is one of several card accounts.

3. The device of claim 1, wherein the data varying loader element is a magnetic strip compatible element.

4. The device of claim 1, wherein the data varying loader element is a chip and pin element.

5. A multi-account dynamic payment card processor-implemented method, comprising:
receiving, by using one or more processors, a dynamic payment card pairing request; effecting, by using the one or more processors, a dynamic payment card pairing package to create a pairing connection, wherein the pairing connection involves a dynamic payment card;
sending, by using the one or more processors, a dynamic payment card generation request;
receiving, by using the one or more processors, a wallet account injection request to inject at least one wallet account into the dynamic payment card;
receiving, by using the one or more processors, a wallet account injection confirmation, wherein the wallet account injection confirmation includes at least one wallet account identifier associated with the at least one wallet account; and
transmitting, by using the one or more processors, the at least one wallet account identifier to the dynamic payment card.

6. A multi-account dynamic payment card non-transitory computer-readable medium storing processor-executable instructions, said instructions executable by a processor to:
receive a dynamic payment card pairing request;
effect a dynamic payment card pairing package to create a pairing connection,
wherein the pairing connection involves a dynamic payment card;
send a dynamic payment card generation request;
receive a wallet account injection request to inject at least one wallet account into the dynamic payment card;
receive a wallet account injection confirmation, wherein the wallet account injection confirmation includes at least one wallet account identifier associated with the at least one wallet account; and
transmit the at least one wallet account identifier to the dynamic payment card.

7. A multi-account dynamic payment card processor-implemented method, comprising:
instantiating a dynamic payment card application on a mobile device;
receiving a dynamic payment card pairing request;
effecting a dynamic payment card pairing package to create a pairing connection,
wherein the pairing connection involves a dynamic payment card;
retrieving, on the mobile device, payment card data associated with at least one payment account;
receiving a payment account injection request to inject the at least one payment account into the dynamic payment card; and
transmitting the retrieved payment card data to the dynamic payment card.

8. The method of claim 7, wherein the retrieved payment card data is received by manual input.

9. The method of claim 7, wherein the retrieved payment card data is received through a payment card reader.

10. The method of claim 7, wherein the paring connection is a wireless pairing connection.

11. A multi-account dynamic payment card non-transitory computer-readable medium storing processor-executable instructions, said instructions executable by a processor to:
instantiate a dynamic payment card application on a mobile device;
receive a dynamic payment card pairing request;
effect a dynamic payment card pairing package to create a pairing connection, wherein the pairing connection involves a dynamic payment card;
retrieve, on the mobile device, payment card data associated with at least one payment account;
receive a payment account injection request to inject the at least one payment account into the dynamic payment card; and
transmit retrieved payment card data to the dynamic payment card.

12. The medium of claim 11, wherein the retrieved payment card data is received by manual input.

13. The medium of claim 11, wherein the retrieved payment card data is received through a payment card reader.

14. The medium of claim 11, wherein the paring connection is a wireless pairing connection.

15. A multi-account dynamic payment card authentication processor-implemented method, comprising:
instantiating a dynamic payment card application on a mobile device; receiving, on the mobile device, payment card data associated with at least one payment account;
transmitting a dynamic payment card authentication request associated with the at least one payment account;
receiving a dynamic payment card authentication confirmation message; and
transmitting the received payment card data to a dynamic payment card.

16. The method of claim 15, wherein the received payment card data is received through a payment card reader.

17. The method of claim 15, wherein the dynamic payment card authentication request is transmitted to a wallet provider for an electronic authentication.

18. A multi-account dynamic payment card authentication non-transitory computer-readable medium storing processor-executable instructions, said instructions executable by a processor to:
instantiate a dynamic payment card application on a mobile device;
receive, on the mobile device, payment card data associated with at least one payment account;
transmit a dynamic payment card authentication request associated with the at least one payment account;
receive a dynamic payment card authentication confirmation message;
transmit the received payment card data to a dynamic payment card.

19. The medium of claim 18, wherein the received payment card data is received through a payment card reader.

20. The medium of claim 18, wherein the dynamic payment card authentication request is transmitted to a wallet provider for an electronic authentication.
